(19) United States
(12) Patent Application Publication
(10) Pub. No.: US 2008/0297015 A1
(43) Pub. Date: Dec. 4, 2008

(54) STORAGE UNIT BACK STOP AND METHOD

(75) Inventors: Allen C. Hager, Grand Rapids, MI (US); Robert E. Jeffers, Ada, MI (US); William K. Hofman, Ada, MI (US); Brian L. Bultsma, Byron Center, MI (US); Scott Michael Miller, Middleville, MI (US); Karl Heinz Mueller, Rosenheim (DE); John R. Hamilton, Grand Rapids, MI (US); Karl J. Mead, East Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Steelcase Inc.

(21) Appl. No.: 12/128,920

(22) Filed: May 29, 2008

Related U.S. Application Data
(60) Provisional application No. 60/940,891, filed on May 30, 2007.
(60) Provisional application No. 60/940,879, filed on May 30, 2007.
(60) Provisional application No. 60/940,899, filed on May 30, 2007.
(60) Provisional application No. 60/940,913, filed on May 30, 2007.

(51) Int. Cl. A47B 96/00; B23P 11/00

(52) U.S. Cl. 312/237; 29/428

(57) ABSTRACT

A storage unit assembly and method for office furniture units includes two end panels and a bottom panel configured to support objects thereon. A back stop rail is connected to end panels and the bottom panel. The back stop rail includes a lower web having a bottom flange and a center flange, wherein the bottom flange abuts the bottom panel of the storage unit, and the center flange extends above the bottom panel into the storage unit. An upper web is connected to the center flange, wherein the upper web extends upwardly and terminates at a top flange. A rear flange extends downwardly from the top flange, wherein the planar extent of the rear flange is substantially coplanar with the planar extent of the lower web.

### CROSS REFERENCE TO RELATED APPLICATIONS

The present application claims benefit under 35 U.S.C. §119(e) of provisional application Ser. No. 60/940,891, entitled STORAGE UNIT BACK STOP AND METHOD; provisional application Ser. No. 60/940,879, entitled STORAGE UNIT ATTACHMENT SYSTEM AND METHODS, filed May 30, 2007; provisional application Ser. No. 60/940,899, entitled STORAGE UNIT DOOR APPARATUS AND METHOD, filed May 30, 2007; and provisional application Ser. No. 60/940,913, filed May 30, 2007, entitled FURNITURE STORAGE UNIT AND METHOD, and is related to co-pending application entitled FURNITURE STORAGE UNIT AND METHOD, filed on even date herewith. The entire contents of each of the aforementioned applications are incorporated herein by reference.

### BACKGROUND OF THE INVENTION

The present invention relates to storage units for office furniture and the like, and in particular to a back stop rail and associated method for use in furniture storage units.

Modular office systems are oftentimes used to convert large open floor spaces in buildings into individual workstations and other useable office settings. Due to constantly changing work environments and limitations in storage areas, office systems that can utilize multiple components and that can be used in a wide variety of applications are quite beneficial. Further, providing a storage unit assembly that allows for efficient use of storage space would also be beneficial.

In an effort to increase the efficient use of space in storage units, components that can provide various functions while taking up only minimal space in the storage unit would be useful. In the past, such arrangements have proven difficult to design and costly to produce. Accordingly, a storage unit construction having internal components that are adapted and can be arranged to increase the efficiency of useable space in the storage unit and which also add structural rigidity to the storage unit would be considered advantageous.

### SUMMARY OF THE INVENTION

One aspect of the present invention is an office furniture storage unit of the type having a top panel, a bottom panel, and first and second end panels disposed at opposite ends of the top and bottom panels and connected therewith to define a rigid, box-shaped case having a generally open interior configured to store objects therein. A dual-function back stop/accessory support has an elongate, rigid, channel-shaped rail connected with the case and extends generally between the first and second end panels within the interior of the case. The rail has a rearwardly opening, generally U-shaped upper portion defined by a generally flat vertical web with upper and lower horizontal flanges projecting rearwardly from opposite sides of the vertical web. The rail is supported along a rear portion of the bottom panel with the vertical web projecting inwardly into the interior of the case to retain objects on the bottom panel. An accessory has a first portion thereof configured to equip the interior of the case, and a second portion thereof detachably engaged with the upper horizontal flange on the rail to hangingly support the accessory from the upper portion of the rail and abuttingly against the vertical web of the rail at a selected one of a wide variety of positions along the rail.

Another aspect of the present invention is an office furniture shelf of the type having a bottom panel and first and second end panels disposed at opposite ends of the bottom panel and connected therewith to define a rigid tray having a generally open upper surface configured to store objects thereon. A dual-function back stop/accessory support has an elongate, rigid, channel-shaped rail connected with and extending generally between the first and second end panels. The rail has a rearwardly opening, generally U-shaped upper portion defined by a generally flat vertical web with upper and lower horizontal flanges projecting rearwardly from opposite sides of the vertical web. The rail is supported along a rear portion of the bottom panel with the vertical web projecting inwardly over the upper surface of the tray to retain objects on the bottom panel. An accessory has a first portion configured to equip the shelf, and a second portion detachably engaged with the upper horizontal flange on the rail to hangingly support the accessory from the upper portion of the rail and abuttingly against the vertical web of the rail at a selected one of a wide variety of positions along the rail.

Another aspect of the present invention is a storage unit assembly for office furniture units that includes a case portion defined by first and second end panels disposed at opposite ends of a top panel and a bottom panel. A back stop rail is connected to the first end panel, the second end panel and the bottom panel. The back stop rail includes a lower web having a bottom flange and a center flange, wherein the bottom flange abuts the bottom panel of the storage unit, and the center flange extends above the bottom panel into the storage unit. An upper web is connected to the center flange, wherein the upper web extends upwardly and terminates at a top flange. A rear flange extends downwardly from the top flange, wherein the planar extent of the rear flange is substantially coplanar with the planar extent of the lower web.

Another aspect of the present invention is a method for making office furniture storage units of the type having a top panel, a bottom panel, and first and second end panels disposed at opposite ends of the top and bottom panels and connected therewith to define a rigid, box-shaped case having a generally open interior configured to store objects therein. The method includes forming an elongate, rigid, channel-shaped dual-function back stop/accessory support rail with a rearwardly opening, generally U-shaped upper portion defined by a generally flat vertical web with upper and lower horizontal flanges projecting rearwardly from opposite sides of the vertical web. The rail is positioned in the interior of the case along a rear portion of the bottom panel with the vertical web projecting inwardly into the interior of the case to retain objects on the bottom panel. An accessory is formed with a first portion thereof configured to equip the interior of the case, and a second portion thereof configured for detachable engagement with the upper horizontal flange on the rail. The second portion of the accessory is detachably mounted on the rail to hangingly support the accessory from the upper portion of the rail and abuttingly against the vertical web of the rail at a selected one of a wide variety of positions along the rail.

Still another aspect of the present invention is a method for making office furniture shelves of the type having a bottom panel and first and second end panels disposed at opposite ends of the bottom panel and connected therewith to define a rigid tray having a generally open upper surface configured to store objects thereon. The method includes forming an elongate, rigid, channel-shaped dual-function back stop/accessory support rail with an inwardly opening, generally U-shaped upper portion defined by a generally flat vertical web with upper and lower horizontal flanges projecting rearwardly from opposite sides of the vertical web. The rail is positioned in the interior of the case along a rear portion of the bottom panel with the vertical web projecting inwardly over the upper surface of the tray to retain objects on the bottom panel. An accessory is formed with a first portion thereof configured to equip the shelf, and a second portion configured for detachable engagement with the upper horizontal flange on the rail. The second portion of the accessory is detachably mounted on the rail to hangingly support the accessory from the upper portion of the rail and abuttingly against the vertical web of the rail at a selected one of a wide variety of positions along the rail.

Yet another aspect of the present invention is a storage unit assembly having a back stop rail designed to support various components suspended therefrom. The back stop rail includes a three-dimensional design that adds aesthetic qualities to both the interior of an associated storage unit assembly or an associated shelf, provides additional structural rigidity, and can be used in multiple environments, including on shelves and inside storage unit assemblies. Accessories suspended from the back stop rail increase the efficient use of storage space inside the storage unit assembly while also taking up minimal or no valuable space on the surface of the bottom panel of the storage unit assembly.

These and other features, advantages and objects of the present invention will be further understood and appreciated by those skilled in the art upon studying the following specification, claims, and appended drawings.

### BRIEF DESCRIPTION OF THE DRAWINGS

FIG. 1 is a top perspective view of the storage unit assembly of the present invention;

FIG. 2 is an enlarged top perspective view of a back stop rail and accessory;

FIG. 3 is a top perspective view of the back stop rail;

FIG. 4 is a side elevational view of the back stop rail of FIG. 3;

FIG. 5 is a top elevational view of the back stop rail of FIG. 3;

FIG. 6 is a rear elevational view of the back stop rail of FIG. 3;

FIG. 7 is a bottom elevational view of the back stop rail of FIG. 3;

FIG. 8 is a top perspective view of an end panel with a rail bracket;

FIG. 9 is a front elevational view of the end panel and rail bracket of FIG. 8;

FIG. 10 is a rear elevational view of the end panel and rail bracket of FIG. 8;

FIG. 11 is an exploded view of a storage unit assembly;

FIG. 12 is an enlarged partial perspective view of an inside corner of a storage unit assembly prior to construction;

FIG. 13 is an enlarged partial perspective view of an inside corner of a storage unit assembly during construction;

FIG. 14 is a front elevational view of a storage unit assembly;

FIG. 15 is a top perspective view of an assembled storage unit assembly and accessory;

FIG. 16 is top perspective view of an accessory;

FIG. 17 is a side elevational view of an accessory;

FIG. 18 is a front elevational view of an accessory;

FIG. 19 is a rear elevational view of an accessory;

FIG. 20 is a top elevational view of an accessory;

FIG. 21 is an enlarged top perspective view of a connecting portion of an accessory;

FIG. 22 is a side elevational view of a storage unit assembly prior to connection with an accessory inside a storage unit assembly;

FIG. 23 is a side elevational view of a storage unit assembly after connection with an accessory;

FIG. 24 is an exploded view of a walled shelf;

FIG. 25 is a top perspective view of a shelf wall and connector bracket;

FIG. 26 is a front elevational view of the shelf wall and connector bracket of FIG. 25;

FIG. 27 is first side elevational view of the shelf wall and connector bracket of FIG. 25;

FIG. 28 is a top elevational view of the shelf wall and connector bracket of FIG. 25;

FIG. 29 is a second side elevational view of the shelf wall and connector bracket of FIG. 25;

FIG. 30 is a top perspective view of a shelf assembly installed on a furniture unit;

FIG. 31 is a side elevational view of an accessory rail mounted on the shelf assembly;

FIG. 32 is a top perspective view of an accessory mounted on the shelf assembly;

FIG. 33A is a top perspective view of a folder support and binder support mounted on a back stop rail;

FIG. 33B is a top perspective view of a folder support, paper tray, and writing utensil holder mounted on a back stop rail;

FIG. 33C is a top perspective view of compact disc dividers mounted on a back stop rail;

FIG. 33D is a top perspective view of a copy stand and a hanging folder support mounted on a back stop rail; and

FIG. 33E is a top perspective view of a hanging folder support and paper divider mounted on a back stop rail.

### DETAILED DESCRIPTION OF PREFERRED EMBODIMENTS

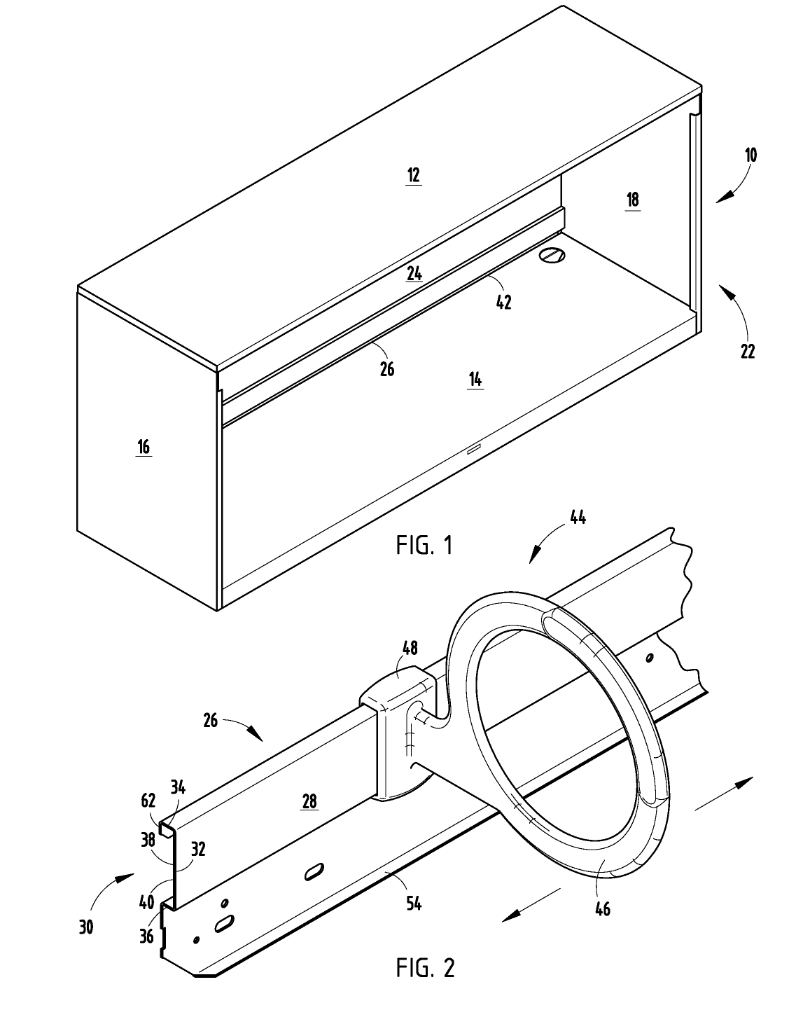

For purposes of description herein the terms “upper”, “lower”, “right”, “left”, “rear”, “front”, “vertical”, “horizontal” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

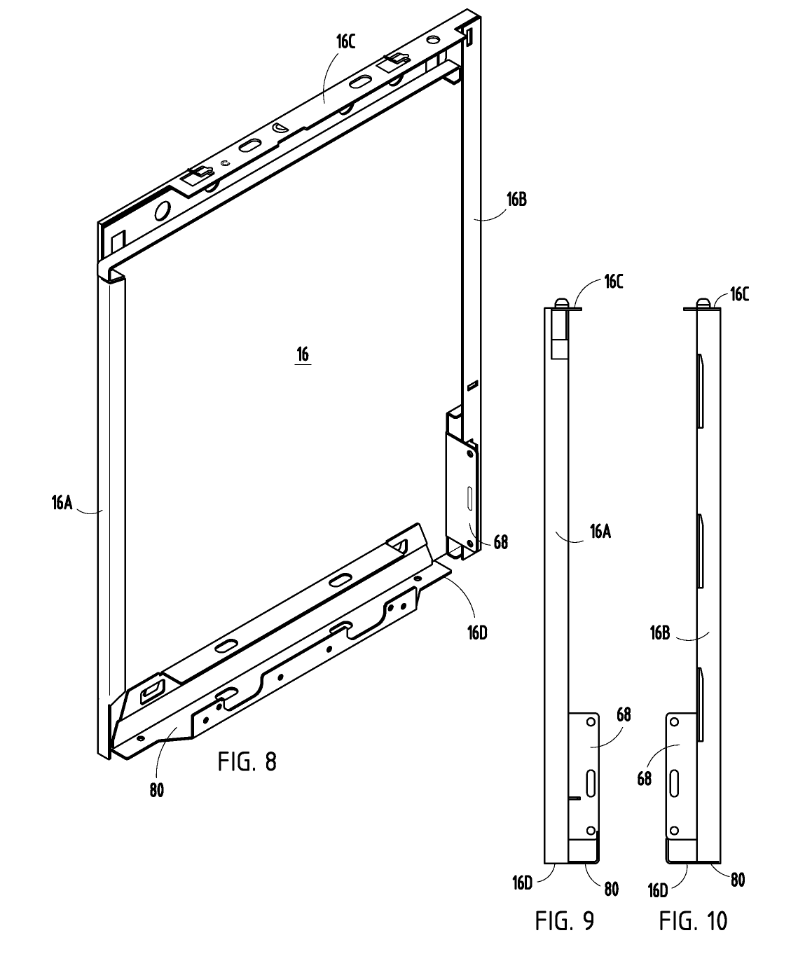

The reference numeral 10 shown in FIGS. 1 and 2 generally designates an office furniture storage unit of the type having a top panel 12, a bottom panel 14, and first and second end panels 16, 18 disposed at opposite ends of the top and bottom panels 12, 14 and connected therewith to define a rigid, box-shaped case 22 having a generally open interior 24 configured to store objects therein. In the example shown in FIGS. 1-23, a dual-function back stop/accessory support 26 has an elongate, rigid, channel-shaped rail 28 connected with the case 22, and extends generally between the first and second end panels 16, 18 within the interior 24 of the case 22. The rail 28 has a rearwardly opening, generally U-shaped upper portion 30 defined by a generally flat vertical web 32 with upper and lower horizontal flanges 34, 36 projecting rearwardly from opposite sides 38, 40 of the vertical web 32. The rail 28 is supported along a rear portion 42 of the bottom panel 14 with the vertical web 32 projecting inwardly into the interior 24 of the case 22 to retain objects on the bottom panel 14. An accessory 44 has a first portion 46 configured to equip the interior 24 of the case 22, and a second portion 48 detachably engaged with the upper horizontal flange 34 on the rail 28 to hangingly support the accessory 44 from the upper portion 30 of the rail 28 and abuttingly against the vertical web 32 of the rail 28 at a selected one of a wide variety of positions along the rail 28.

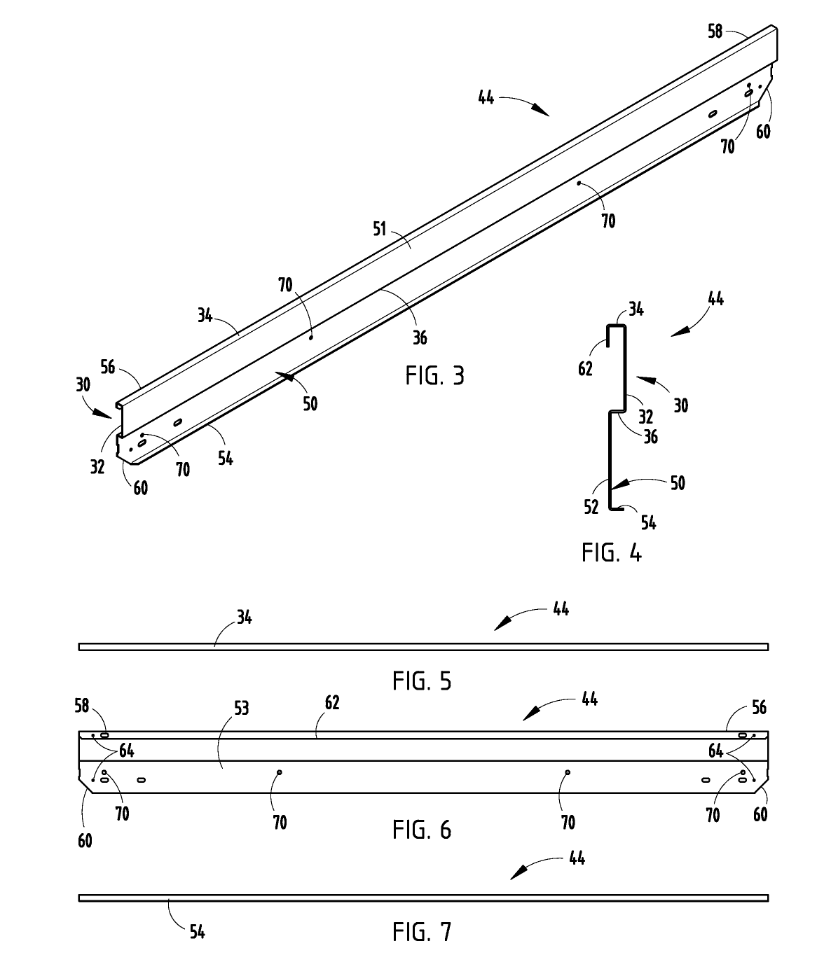

As shown in FIGS. 3-7, the illustrated rail 28 is defined by a rearwardly opening, generally U-shaped upper portion 30 and a forwardly opening, generally U-shaped lower portion 50. Flat vertical web 32, upper horizontal flange 34 and lower horizontal flange 36 define the upper portion 30. Lower portion 50 of rail 28 is defined by lower horizontal flange 36 of upper portion 30, a lower flat web 52, and a lower horizontal flange 54 of lower portion 50. Fastener apertures are adapted to receive fasteners for attaching rail 28 to bottom panel 14 and extend through a front side 51 to a backside 53. First and second ends 56, 58 of rail 28 include tapered portions 60 that assist a user to install rail 28. Upper portion 30 includes a rear flange 62 projecting downwardly from upper horizontal flange 34 and substantially parallel with flat vertical web 32 of upper portion 30. Large fastener apertures 64 aligned vertically on first and second ends 56, 58 of rail 28 and that extend through rear flanges 62 are adapted to receive fasteners that connect rail 28 to fastener apertures 67 in rail brackets 68 (FIG. 12). Rail 28 includes multiple small fastener apertures 70 projecting through lower forwardly opening generally U-shaped lower portion 50 along the longitudinal extent of rail 28. Rail 28 can be any size and it should be understood that when rail 28 is very long, many small fastener apertures 70 are added to properly secure rail 28 to bottom panel 14.

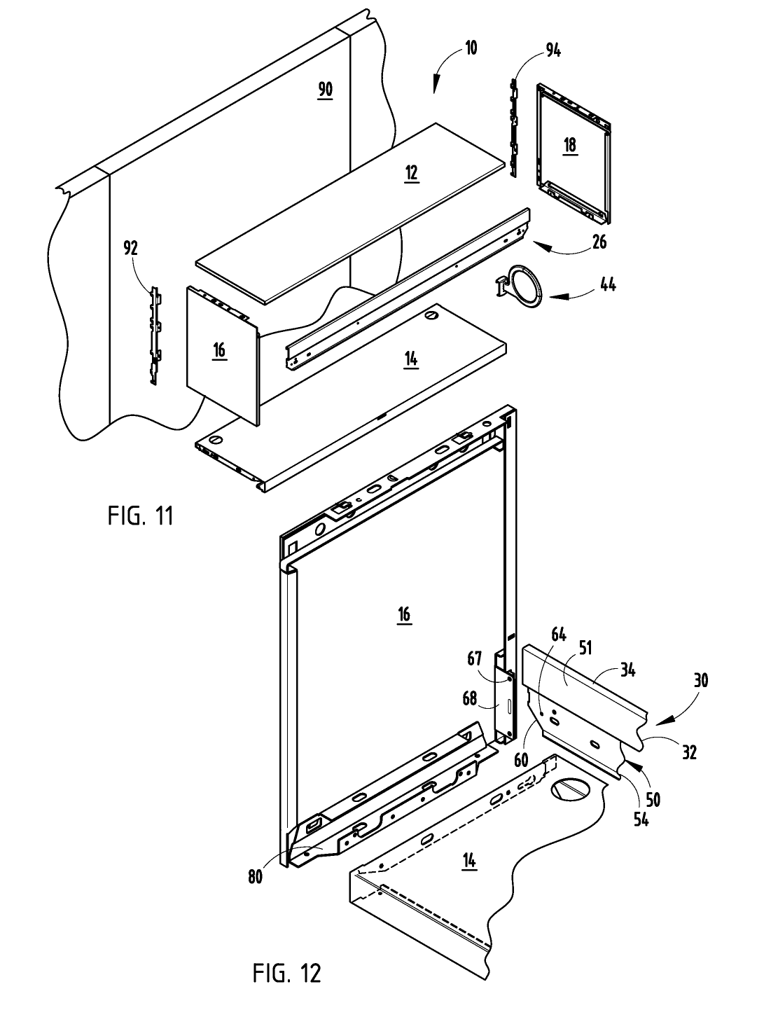

Referring again to FIG. 11, the illustrated embodiment of first end panel 16 has a front end 16A, rear end 16B, top end 16C and bottom end 16D. First end panel 16 also includes a connector bracket 80 located proximate bottom end 16D and adapted to connect with and support bottom panel 14. A rail bracket 68 extends substantially orthogonally inwardly from end panel 16 and is adapted to connect with rail 28. Rail bracket 68 is fastened to a backside 53 of rail 28 and prevents rail 28 from bending as a result of torsional forces applied by accessories suspended from rail 28. Second end panel 18 has a similar construction but has a mirror-image construction to that of first end panel 16.

As shown in FIGS. 11-14, rail 28 is designed for installation in a storage unit assembly 10 that is used with an office furniture system 90. Storage unit assembly 10 includes first and second hanger brackets 92, 94, first and second end panels 16, 18 adapted to engage first and second hanger brackets 92, 94, bottom panel 14, top panel 12, and rail 28 and may include further components as described in copending U.S. patent application Ser. No. ______ , filed ______ , entitled FURNITURE STORAGE UNIT AND METHOD, which is hereby incorporated herein by reference. First and second hanger brackets 92, 94 suspend storage unit assembly 10 by engaging slots 95 in end panels 16 and 18.

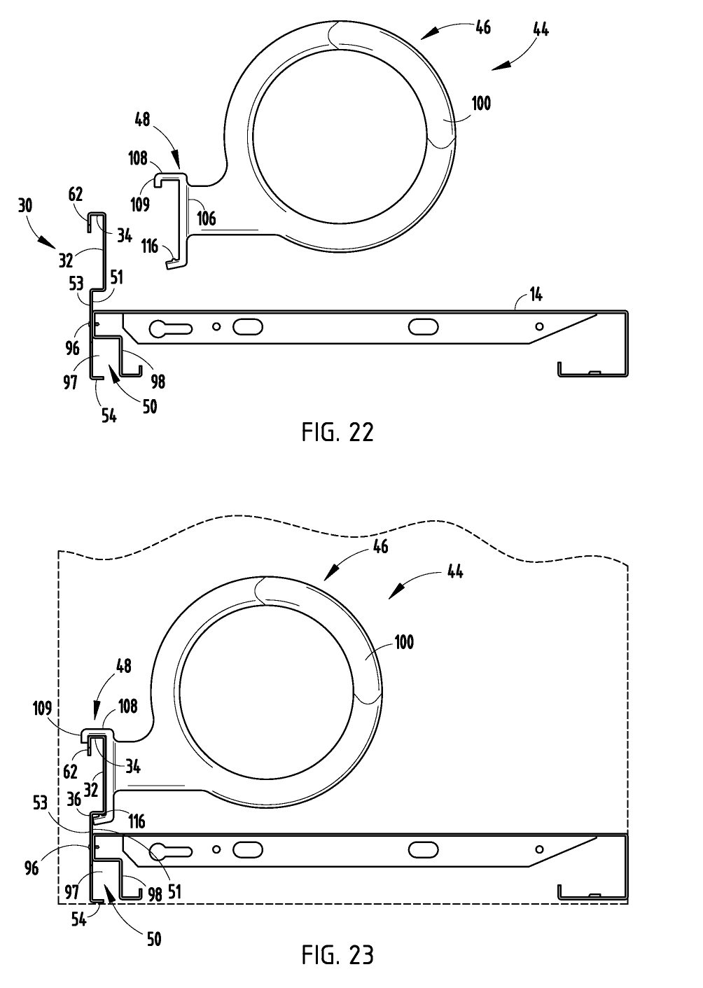

As shown in FIGS. 22 and 23, bottom panel 14 is received in U-shaped lower portion 50 of rail 28 and is fastened thereto by mechanical fasteners 96. Bottom panel 14 connects with forwardly opening, generally U-shaped lower portion 50 to create a space 97 between a lower flange 98 of bottom panel 14. Lower flange 98 is configured to receive and retain a light assembly to illuminate a work space located below storage unit assembly 10. in addition, space 97 provides ample room for an off-module bracket (not shown) to engage back stop rail 28, as further disclosed in U.S. Patent Provisional Ser. No. 60/940,879, filed May 30, 2007, entitled STORAGE UNIT ATTACHMENT ARRANGEMENT AND METHODS which is hereby incorporated herein by reference.

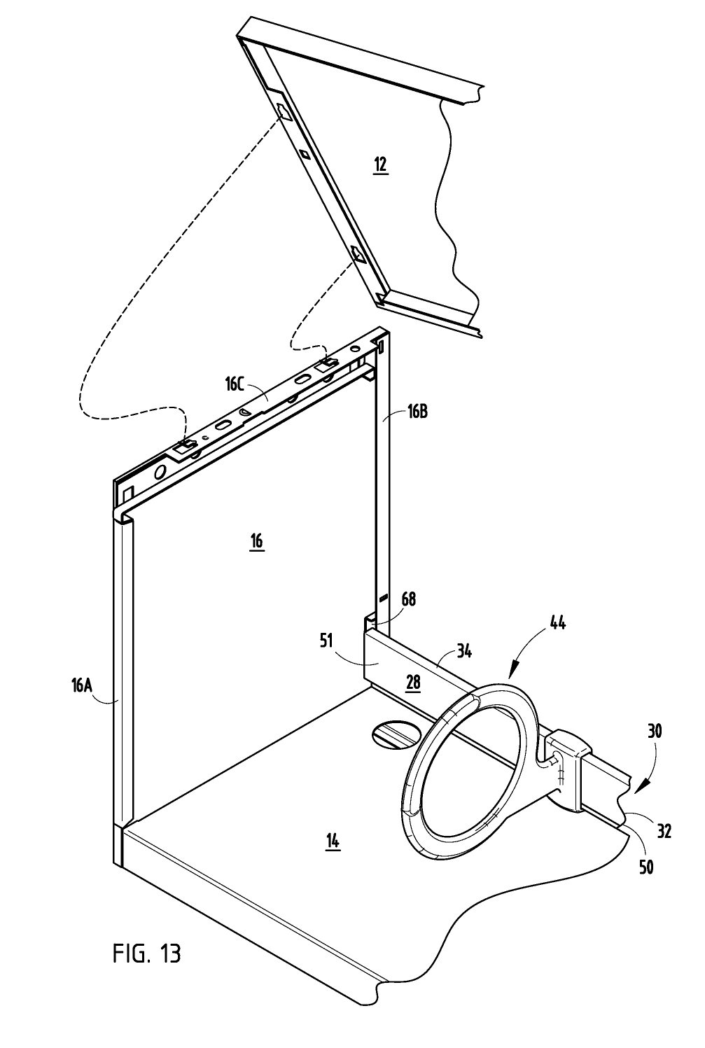

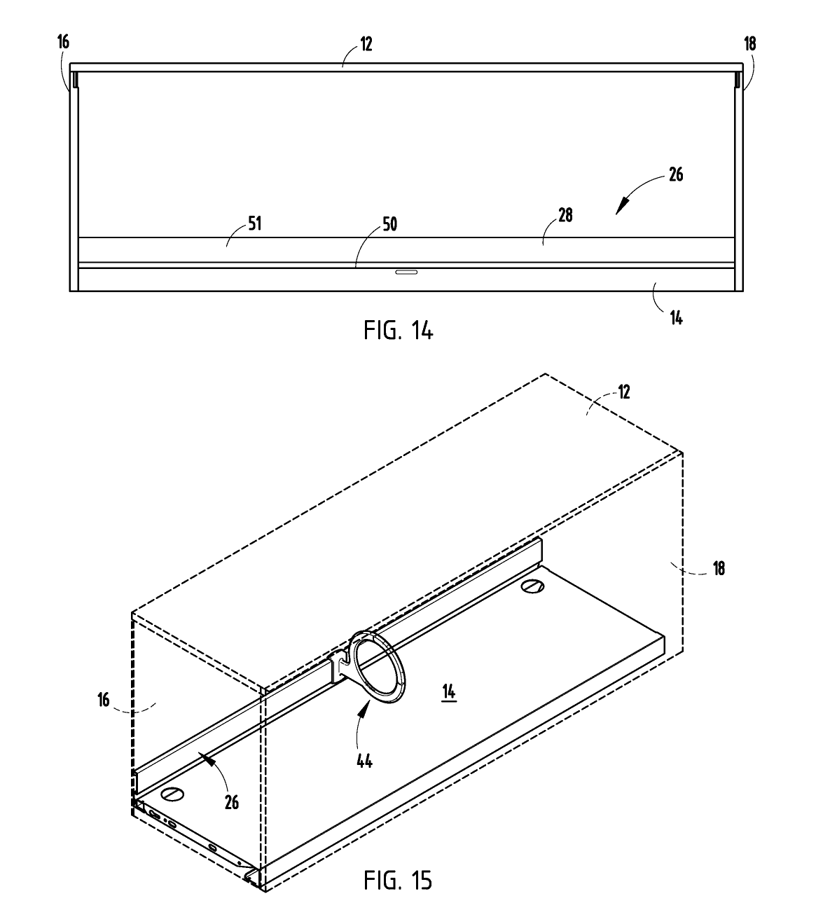

As shown in FIG. 12, to assemble storage unit assembly 10, bottom panel 14 is first fastened to rail 28, and then bottom panel 14 and rail 28 are engaged with first end panel 16 and second end panel 18. First end 56 of rail 28 is placed in front of and fastened to rail bracket 68 fixedly attached to first end panel 16, as shown in FIG. 13. Similarly, second end 58 of rail 28 is placed in front of and fastened to rail bracket 68 fixedly attached to second end panel 18. Top panel 12 is then installed on first and second end panels 16, 18 to create case 22 (FIGS. 14 and 15).

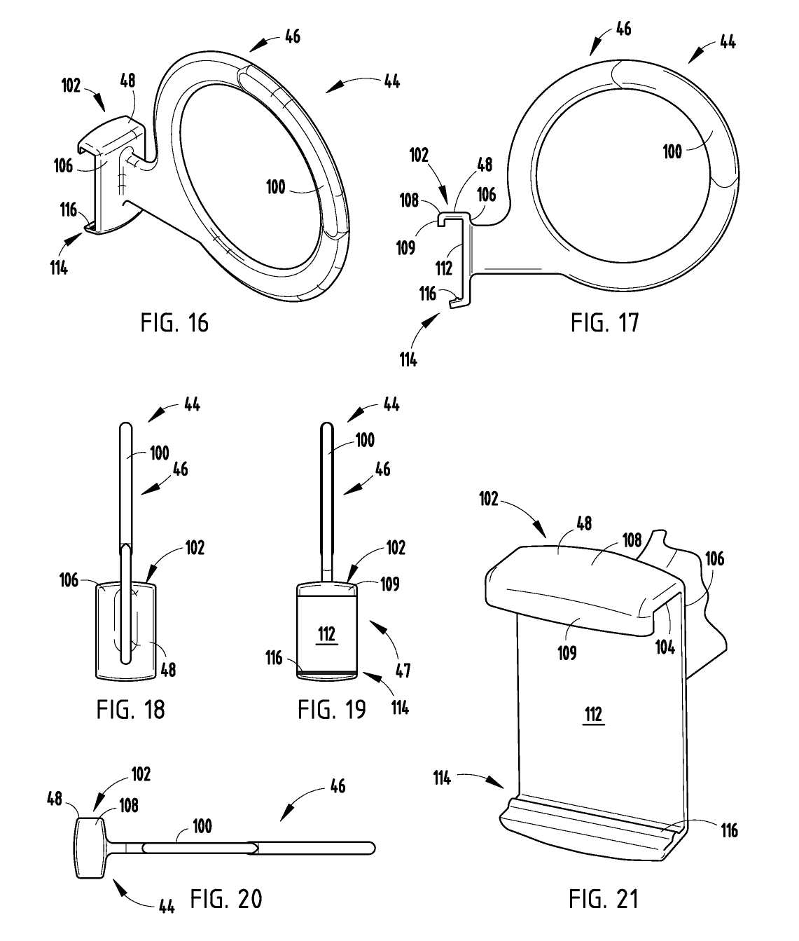

Referring now to FIGS. 16-21, the illustrated accessory 44 includes a first portion 46 and a second portion 48. First portion 46 of accessory 44 is configured to equip interior 24 of case 22 and can be used as a divider to retain objects on bottom panel 14 in an upright orientation. Accessory 44 also includes a vertically annular shape 100 which defines both a divider and a wire manager. A hook-shaped upper portion 102 of second portion 48 of accessory 44 has an inverted U-shaped configuration 104 defined by a forward vertical leg 106, an upper horizontal leg 108 disposed generally perpendicular with forward vertical leg 106 and a rearward vertical leg 109 spaced apart from and disposed generally parallel with forward vertical leg 106. A lower portion 114 of accessory 44 extends rearwardly from flat rear wall 112 and includes an inwardly protruding lip 116 selectively engaging lower horizontal flange 36 on rail 28 to detachably retain accessory 44 on rail 28. Inwardly protruding lip 116 extends across the lateral extent of lower portion of accessory 44 and abuts lower horizontal flange 36 on upper portion 30 of rail 28 to provide sufficient frictional contact to keep accessory 44 from tipping off rail 28. Also, inwardly protruding lip 116 provides a snap-fit engagement providing the user with audible and tactile confirmation that accessory 44 has been installed.

Referring again to FIGS. 16-21, hook-shaped upper portion 102 abuttingly engages rear flange 62 to detachably support accessory 44 on rail 28. Hook-shaped upper portion 102 of accessory 44 is configured to permit horizontal sliding of accessory 44 longitudinally along the rail 28 to any of a number of predetermined locations on rail 28. The generally flat rear wall 112 of accessory 44 is disposed between upper portion 102 and lower portion 114 and is designed to selectively abuttingly engage vertical web 32 of rail 28 to detachably yet securely support accessory 44 on rail 28 in a manner that permits sliding accessory 44 to a wide variety of positions along rail 28.

As illustrated in the embodiment shown in FIGS. 22 and 23, accessory 44 is inserted on rail 28 by installing the inverted U-shaped configuration 104 of accessory 44 over upper horizontal flange 34 at an angle and rotating accessory 44 downwardly until inwardly protruding lip 116 is in contact with or, at least proximate to, lower horizontal flange 36. Accessory 44 is now suspended from rail 28 above bottom panel 14. Referring to FIG. 23, forward vertical leg 106 of inverted U-shaped configuration 104 selectively overlies an adjacent portion of vertical web 32 on rail 28, upper horizontal leg 108 selectively overlies an adjacent portion of upper horizontal flange 36 on rail 28, and rearward vertical leg 109 selectively overlies an adjacent portion of rear flange 62 on rail 28. Accessory 44 is designed to withstand torsional forces applied to second portion 48 by books, binders, etc. that may lean against and be supported by accessory 44. Further, accessory 44 can be used to divide binders, books, folder, etc. while at the same time provide a wire manager for routing wires across the lateral extent of case 22. Accessory 44 is also capable of use in the same manner by being suspended from a post and beam arrangement or hung from a slat wall. Case 22 may include one of a variety of doors and door opening systems as described in further detail in U.S. Provisional Application Ser. No. 60/940,899, filed May 30, 2007, entitled STORAGE UNIT DOOR APPARATUS AND METHOD, which is hereby incorporated herein by reference.

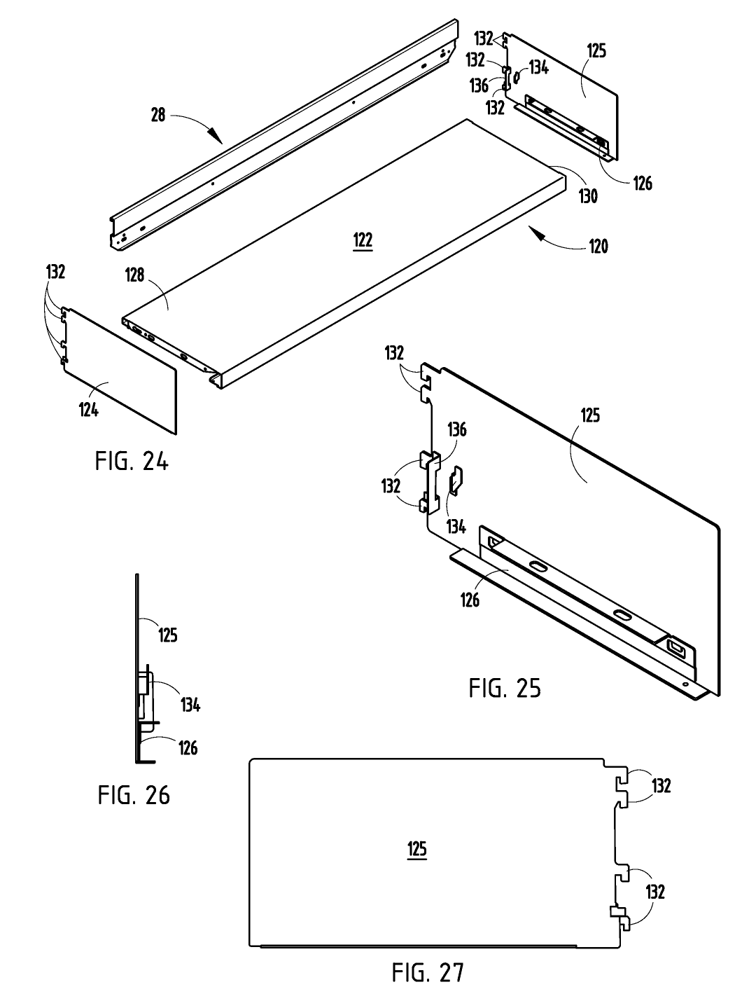

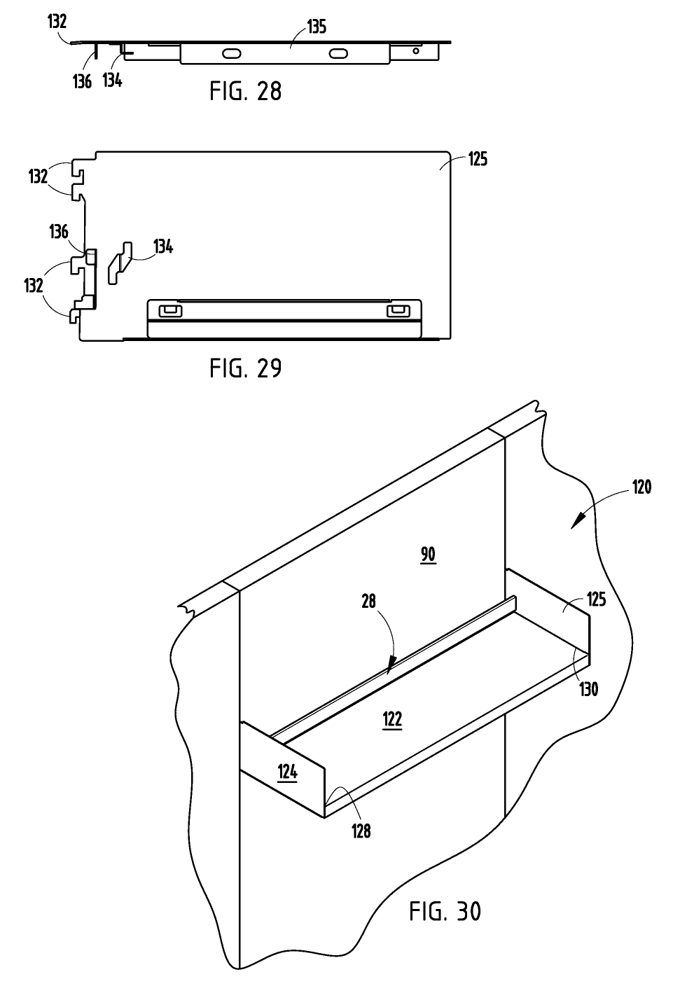

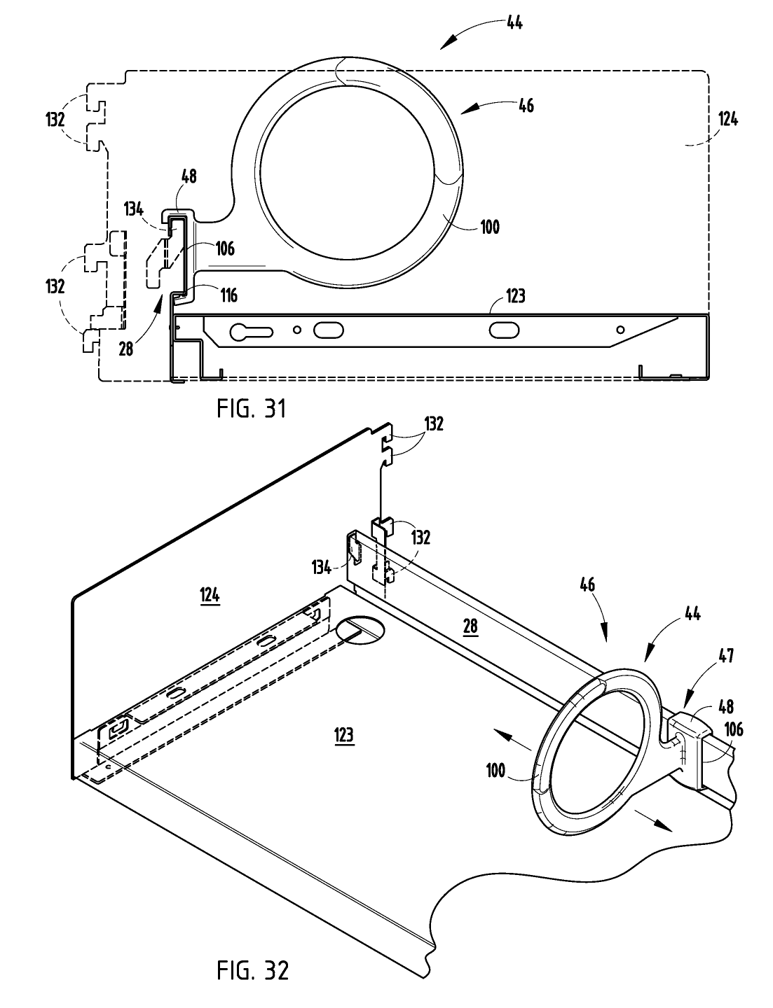

Referring now to FIGS. 24, 31, and 32, rail 28 may also be installed on a panel-hung shelf, such as the walled shelf system 120 shown in FIG. 30. The walled shelf system 120 includes first and second shelf walls 124, 125 (FIGS. 25-29) having connector brackets 126 that engage first and second sides 128, 130 of a shelf 122, integral hooks 132 designed to suspend a shelf 122 having a top tray portion 123, and shelf rail brackets 134 designed to abut and support rail 28 when installed on shelf 122. An anti-dislodgement clip 136 is also provided and keeps shelf 122 from being accidentally dislodged by a user. First shelf wall 124 and second shelf wall 125 have a mirror image construction with like components. After assembly (FIG. 30), shelf 122 can be used to support various objects thereon and rail 28 keeps those items from contacting an office furniture system 90 and also provides a structure from which accessories 44 may be hung. It is contemplated that various other accessories may be suspended from rail 28.

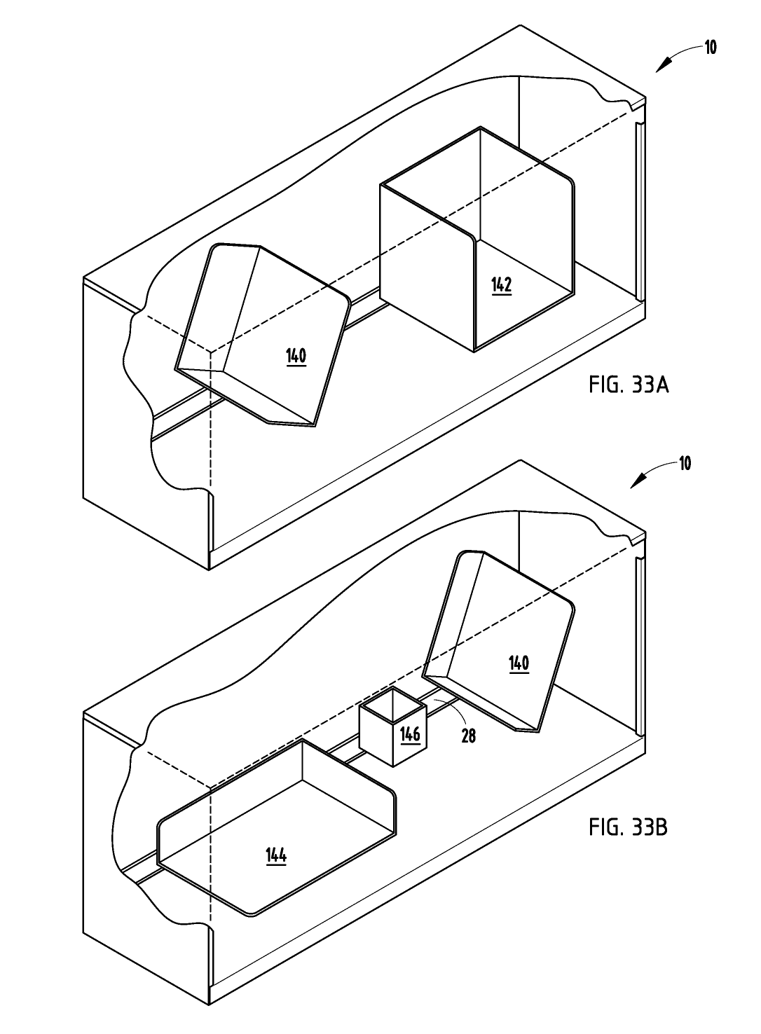

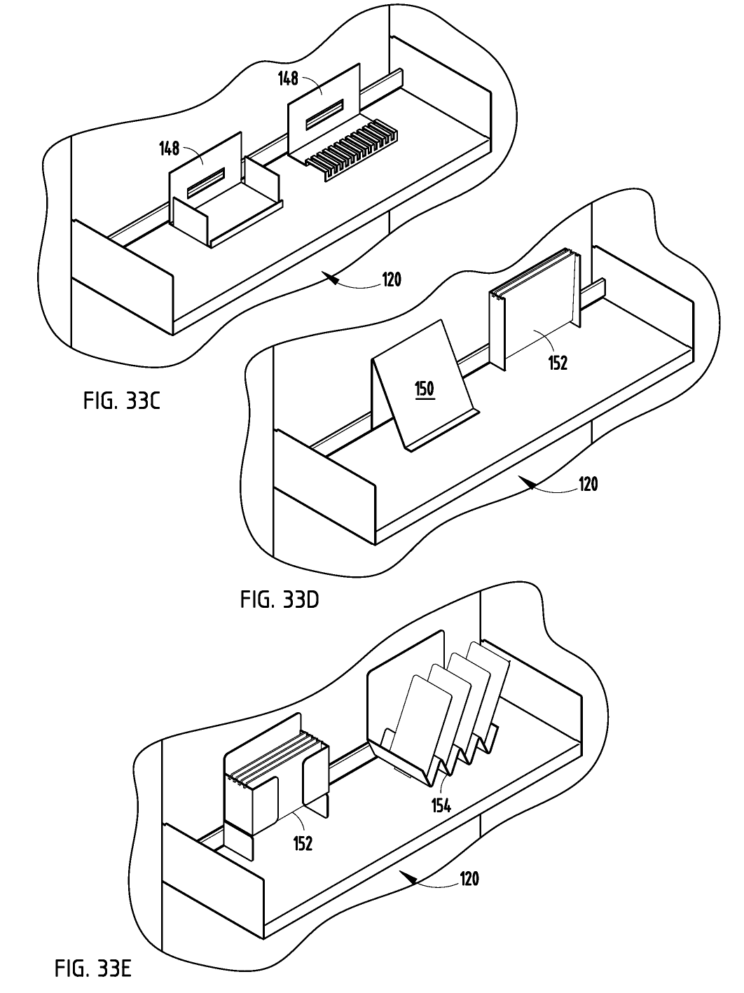

As shown in FIGS. 33A-33E, multiple different accessories may be hung from rail 28, including folder supports 140 and binder supports 142 that may be oriented vertically or diagonally in relation to rail 28. In addition, paper trays 144 and writing utensil holders 146 may be supported from rail 28, as shown in FIG. 33B. Compact disc dividers 148, copy stands 150, hanging folder supports 152, and paper dividers 154 may also be installed on rail 28. It should be understood that each of the aforementioned accessories may be supported on rail 28 in a storage unit 10 or on a walled shelf system 120.

A method for making an office furniture storage unit includes forming an elongate, rigid, channel-shaped dual-function back stop/accessory support rail 26 with a rearwardly opening, generally U-shaped upper portion 30 defined by a generally flat vertical web 32 with upper and lower horizontal flanges 34, 36 projecting rearwardly from opposite sides of the vertical web 32. The rail 26 is positioned in the interior 24 of the case 22 along the rear portion 42 of the bottom panel 14 with the vertical web 32 projecting inwardly into the interior 24 of the case 22 to retain objects on the bottom panel 14. The accessory 44 is formed with the first portion 46 thereof configured to equip the interior 24 of the case 22, and the second portion 48 thereof configured for detachable engagement with the upper horizontal flange 34 on the rail 28. The second portion 48 of the accessory 44 is detachably mounted on the rail 28 to hangingly support the accessory 44 from the upper portion of the rail 28 and abuttingly against the vertical web 32 of the rail 28 at a selected one of a wide variety of positions along the rail 28.

A method for making a shelf includes forming an elongate, rigid, channel-shaped dual-function back stop/accessory support rail 28 with an inwardly opening, generally U-shaped upper portion 30 defined by a generally flat vertical web 32 with upper and lower horizontal flanges 34, 36 projecting rearwardly from opposite sides of the vertical web 32. The rail 28 is positioned in the interior 24 of the case 22 along the rear portion 42 of the bottom panel 14 with the vertical web 32 projecting inwardly over the upper surface of the tray 123 to retain objects on the bottom panel 14. The accessory 44 is formed with the first portion 46 thereof configured to equip the shelf 122, and the second portion 48 configured for detachable engagement with the upper horizontal flange 36 on the rail 28. The second portion 48 of the accessory 44 is detachably mounted on the rail 28 to hangingly support the accessory 44 from the upper portion 30 of the rail 28 and abuttingly against the vertical web 32 of the rail 28 at a selected one of a wide variety of positions along the rail 28.

The above description is considered that of the preferred embodiments only. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

The invention claimed is:

1. In an office furniture storage unit of the type having a top panel, a bottom panel, and first and second end panels disposed at opposite ends of said top and bottom panels and connected therewith to define a rigid, box-shaped case having a generally open interior configured to store objects therein, the improvement of a dual-function back stop/accessory support comprising:
an elongate, rigid, channel-shaped rail connected with said case and extending generally between said first and second end panels within said interior of said case; said rail having a rearwardly opening, generally U-shaped upper portion defined by a generally flat vertical web with upper and lower horizontal flanges projecting rearwardly from opposite sides of said vertical web; said rail being supported along a rear portion of said bottom panel with said vertical web projecting inwardly into said interior of said case to retain objects on said bottom panel; and
an accessory having a first portion thereof configured to equip said interior of said case, and a second portion thereof detachably engaged with said upper horizontal flange on said rail to hangingly support said accessory from said upper portion of said rail and abuttingly against said vertical web of said rail at a selected one of a wide variety of positions along said rail.

2. An office furniture storage unit as set forth in claim 1, wherein:
said rail includes a rear flange depending from a rear edge of said upper horizontal flange, and having a bottom edge; and
said second portion of said accessory includes a hook-shaped upper portion which abuttingly engages said bottom edge of said rear flange to detachably support said accessory on said rail.

3. An office furniture storage unit as set forth in claim 1, wherein:
said second portion of said accessory is configured to permit sliding said accessory longitudinally along said rail to a predetermined location thereon.

4. An office furniture storage unit as set forth in claim 1, wherein:
said second portion of said accessory includes a lower portion with an inwardly protruding lip selectively engaging said lower horizontal flange on said rail to detachably retain said accessory on said rail.

5. An office furniture storage unit as set forth in claim 1, wherein:
said second portion of said accessory includes a generally flat rear wall selectively abuttingly engaging said vertical web on said rail.

6. An office furniture storage unit as set forth in claim 1, wherein:
said second portion of said accessory has an inverted U-shaped configuration defined by a forward vertical leg selectively overlying an adjacent portion of said vertical web on said rail, an upper horizontal leg disposed generally perpendicular with said forward vertical leg and selectively overlying an adjacent portion of said upper horizontal flange on said rail, and a rearward vertical leg spaced apart from and disposed generally parallel with said forward vertical leg.

7. An office furniture storage unit as set forth in claim 1, including:
fasteners detachably connecting opposite end portions of said rail with said first and second end panels.

8. An office furniture storage unit as set forth in claim 1, wherein:
said first portion of said accessory includes a divider shaped to retain objects stored on said bottom panel in an upright orientation.

9. An office furniture storage unit as set forth in claim 1, wherein:
said first portion of said accessory includes a wire manager configured to facilitate routing wires through said interior of said case.

10. An office furniture storage unit as set forth in claim 1, wherein:
said first portion of said accessory has a vertically oriented annular shape which defines both a divider and a wire manager.

11. An office furniture storage unit as set forth in claim 1, wherein:
said rail includes an outwardly opening, generally U-shaped lower portion defined by a generally flat rear web, a lower horizontal flange projecting forwardly from a lower end of said rear web, and said lower horizontal flange of said upper portion of said rail.

12. An office furniture storage unit as set forth in claim 11, wherein:
said rear portion of said bottom panel is received and retained in said U-shaped lower portion of said rail.

13. In an office furniture shelf of the type having a bottom panel and first and second end panels disposed at opposite ends of said bottom panel and connected therewith to define a rigid tray having a generally open upper surface configured to store objects thereon, the improvement of a dual-function back stop/accessory support comprising:
an elongate, rigid, channel-shaped rail connected with and extending generally between said first and second end panels; said rail having an inwardly opening, generally U-shaped upper portion defined by a generally flat vertical web with upper and lower horizontal flanges projecting rearwardly from opposite sides of said vertical web; said rail being supported along a rear portion of said bottom panel with said vertical web projecting inwardly over said upper surface of said tray to retain objects on said bottom panel; and
an accessory having a first portion thereof configured to equip said shelf, and a second portion detachably engaged with said upper horizontal flange on said rail to hangingly support said accessory from said upper portion of said rail and abuttingly against said vertical web of said rail at a selected one of a wide variety of positions along said rail.

14. An office furniture shelf as set forth in claim 13, wherein:
said rail includes a rear flange depending from a rear edge of said upper horizontal flange, and having a bottom edge; and
said second portion of said accessory includes a hook-shaped upper portion which abuttingly engages said bottom edge of said rear flange to detachably support said accessory on said rail.

15. An office furniture shelf as set forth in claim 14, wherein:
said hook-shaped upper portion of said accessory is configured to permit sliding said accessory longitudinally along said rail to a predetermined location thereon.

16. An office furniture shelf as set forth in claim 15, wherein:
said second portion of said accessory includes a lower portion with an inwardly protruding lip selectively engaging said lower horizontal flange on said rail to detachably retain said accessory on said rail.

17. An office furniture shelf as set forth in claim 16, wherein:
said second portion of said accessory includes a generally flat rear wall disposed between said upper and lower portions of said accessory, and selectively abuttingly engaging said vertical web on said rail.

18. An office furniture shelf as set forth in claim 17, wherein:
said upper portion of said accessory has an inverted U-shaped configuration defined by a forward vertical leg selectively overlying an adjacent portion of said vertical web on said rail, an upper horizontal leg disposed generally perpendicular with said forward vertical leg and selectively overlying an adjacent portion of said upper horizontal flange on said rail, and a rearward vertical leg spaced apart from and disposed generally parallel with said forward vertical leg and selectively overlying an adjacent portion of said rear flange on said rail.

19. An office furniture shelf as set forth in claim 13, wherein:
said first portion of said accessory has a vertically oriented annular shape which defines both a divider and a wire manager.

20. An office furniture shelf as set forth in claim 13, wherein:
said rail includes an outwardly opening, generally U-shaped lower portion defined by a generally flat rear web, a lower horizontal flange projecting forwardly from a lower end of said rear web, and said lower horizontal flange of said upper portion of said rail.

21. An office furniture shelf as set forth in claim 20, wherein:
said rear portion of said bottom panel is received and retained in said U-shaped lower portion of said rail.

22. A storage unit assembly for office furniture units, comprising:
a case portion defined by first and second end panels disposed at opposite ends of a top panel and a bottom panel, said case further defined by a back stop rail connected to said first end panel, said second end panel and said bottom panel, said back stop rail comprising:
a lower web having a bottom flange and a center flange, wherein said lower web abuts said bottom panel of said storage unit, and said center flange extends above said bottom panel into said storage unit;
an upper web connected to said center flange, wherein said upper web extends upwardly and terminates at a top flange; and
a rear flange extending downwardly from said top flange, wherein the planar extent of said rear flange is substantially coplanar with the planar extent of said lower web.

23. The storage unit assembly as set forth in claim 22, wherein:
said rear flange is fastened to first and second brackets fixedly attached to said first and second end panels, respectively, of said storage unit.

24. The storage unit assembly as set forth in claim 23, wherein:
said lower web of said back stop rail is attached to said bottom panel.

25. The storage unit assembly as set forth in claim 24, including:
an accessory including first and second attachment legs, wherein a distal end of said first attachment leg abuts said rear flange.

26. The storage unit assembly as set forth in claim 25, wherein:
a distal end of said second attachment leg abuts said lower web.

27. In a method for making office furniture storage units of the type having a top panel, a bottom panel, and first and second end panels disposed at opposite ends of said top and bottom panels and connected therewith to define a rigid, box-shaped case having a generally open interior configured to store objects therein, the improvement comprising:
forming an elongate, rigid, channel-shaped dual-function back stop/accessory support rail with a rearwardly opening, generally U-shaped upper portion defined by a generally flat vertical web with upper and lower horizontal flanges projecting rearwardly from opposite sides of the vertical web;
positioning the rail in the interior of the case along a rear portion of the bottom panel with the vertical web projecting inwardly into the interior of said case to retain objects on the bottom panel;
forming an accessory with a first portion thereof configured to equip the interior of the case, and a second portion thereof configured for detachable engagement with the upper horizontal flange on said rail; and
detachably mounting the second portion of the accessory on the rail to hangingly support the accessory from the upper portion of the rail and abuttingly against the vertical web of said rail at a selected one of a wide variety of positions along said rail.

28. In a method for making office furniture shelves of the type having a bottom panel and first and second end panels disposed at opposite ends of said bottom panel and connected therewith to define a rigid tray having a generally open upper surface configured to store objects thereon, the improvement comprising:
forming an elongate, rigid, channel-shaped dual-function back stop/accessory support rail with an inwardly opening, generally U-shaped upper portion defined by a generally flat vertical web with upper and lower horizontal flanges projecting rearwardly from opposite sides of the vertical web;
positioning the rail in the interior of the case along a rear portion of the bottom panel with said vertical web projecting inwardly over the upper surface of said tray to retain objects on the bottom panel;
forming an accessory with a first portion thereof configured to equip the shelf, and a second portion configured for detachable engagement with the upper horizontal flange on said rail; and
detachably mounting the second portion of the accessory on the rail to hangingly support the accessory from the upper portion of the rail and abuttingly against the vertical web of the rail at a selected one of a wide variety of positions along the rail.
